(19) United States
(12) Patent Application Publication
(10) Pub. No.: US 2020/0127316 A1
(43) Pub. Date: Apr. 23, 2020

(54) FUEL CELL STACK

(71) Applicant: HONDA MOTOR CO., LTD., Tokyo (JP)

(72) Inventors: Hideharu Naito, Wako-shi (JP); Takaaki Shikano, Wako-shi (JP)

(21) Appl. No.: 16/656,613

(22) Filed: Oct. 18, 2019

(30) Foreign Application Priority Data
Oct. 22, 2018 (JP) 2018-198401

(51) Int. Cl. H01M 8/2475; H01M 8/241

(52) U.S. Cl. CPC H01M 8/2475; H01M 8/241

(57) ABSTRACT

A fuel cell stack includes a stack body having a plurality of power generation cells that are stacked together, a pair of end plates, a case, and a coupling bar provided on a lateral side of the stack body, between a pair of end plates for coupling the end plates together. Positioning structure is provided in an inner surface of the case and the coupling bar, for defining positions of the inner surface and the coupling bar with respect to each other. The coupling bar includes an engaging part which engages with engaged parts formed in the stack body, respectively, and an insulating resin layer provided on a side of the coupling bar including the engaging part closer to the stack body.

### CROSS-REFERENCE TO RELATED APPLICATION

This application is based upon and claims the benefit of priority from Japanese Patent Application No. 2018-198401 filed on Oct. 22, 2018, the contents of which are incorporated herein by reference.

### BACKGROUND OF THE INVENTION

### Field of the Invention

The present invention relates to a fuel cell stack formed by stacking a plurality of power generation cells together.

### Description of the Related Art

As shown in the specification of U.S. Patent Application Publication No. 2016/0072145, a fuel cell stack includes a stack body formed by stacking a plurality of power generation cells. Each of the power generation cells performs power generation using a fuel gas and an oxygen-containing gas. Each of the power generation cells includes a membrane electrode assembly (MEA) including an anode, an electrolyte membrane, and a cathode that are stacked together, and a pair of separators sandwiching the MEA. The separators are bipolar plates.

Further, the separator disclosed in the specification of U.S. Patent Application Publication No. 2016/0072145 includes a tab (datum) at a predetermined position in an outer marginal portion of the separator. The tab protrudes outward. In an assembled state where the stack body is placed in a case (housing), the tab is placed in a recess of the case. In the structure, when a load is applied to the fuel cell stack, lateral displacement among the separators is prevented.

The tab of this type is made of insulating resin material, and coupled to a separator made of electrically conductive material (metal material) formed by outsert molding, etc., for preventing electrical conduction between the separators and the case.

### SUMMARY OF THE INVENTION

In the fuel cell stack disclosed in the specification of U.S. Patent Application Publication No. 2016/0072145, since the insulating resin material is provided in the outer marginal portion of each separator, the production cost is increased. It may be possible to adopt structure which does not include any insulating resin material in the outer marginal portion of the separator. However, in this case, it is required to provide large clearance between the case made of metal material and the separator where electric current flows at the time of power generation, for preventing electrical conduction between the case and the separator. However, increase in the size of the clearance may cause various disadvantages. For example, the size of the fuel cell stack becomes large, and the performance of suppressing lateral displacement among the stacked power generation cells is lowered.

The present invention has been made to solve the above problems, and an object of the present invention is to provide a fuel cell stack having simple structure in which it is possible to significantly reduce the production cost, suppress increase in the size of a case, and suitably prevent lateral displacement among a plurality of power generation cells.

In order to achieve the above object, according to an aspect of the present invention, a fuel cell stack is provided. The fuel cell stack includes a stack body including a plurality of power generation cells that are stacked together in a stacking direction, a pair of end plates provided at both ends of the stack body in the stacking direction, a case containing the stack body, and a coupling bar provided on a lateral side of the stack body, and between the pair of end plates, wherein positioning structure is provided in an inner surface of the case and the coupling bar, the positioning structure being configured to define positions of the inner surface of the case and the coupling bar with respect to each other, and the coupling bar includes an engaging part that engages with an engaged part formed in the stack body, and an insulating resin layer provided on a side of the coupling bar including the engaging part, closer to the stack body.

The above fuel cell stack includes the positioning structure and the engaging part. In the structure, in the state where the position of the coupling bar with respect to the case is defined, it is possible to prevent lateral displacement among a plurality of power generation cells by the engaging part. Further, the coupling bar includes the insulating resin layer on a side closer to the stack body. In the structure, even if the engaging part engages with the engaged part of the stack body, it is possible to suitably maintain insulation between the coupling bar and the stack body. Further, the coupling bar contacts the stack body for engagement with the power generation cells. In the structure, increase in the size of the case is suppressed. Further, using the coupling bar, no insulating structure around the plurality of power generation cells is needed. In the structure, it is possible to significantly reduce the production cost of the fuel cell stack.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is an exploded perspective view schematically showing a fuel cell stack according to an embodiment of the present invention;

FIG. 2 is an exploded perspective view showing a power generation cell of the fuel cell stack;

FIG. 3A is a partial perspective view showing engagement between a coupling bar and extensions of the power generation cells;

FIG. 3B is a view showing an engagement state of the coupling bar, the power generation cell, and an internal surface of a case;

FIG. 4A is a view showing positioning structure according to a first modified embodiment;

FIG. 4B is a view showing positioning structure according to a second modified embodiment; and

FIG. 4C is a view showing engagement structure according to a third modified embodiment.

### DESCRIPTION OF THE PREFERRED EMBODIMENTS

Hereinafter, preferred embodiments of the present invention will be described in detail with reference the accompanying drawings.

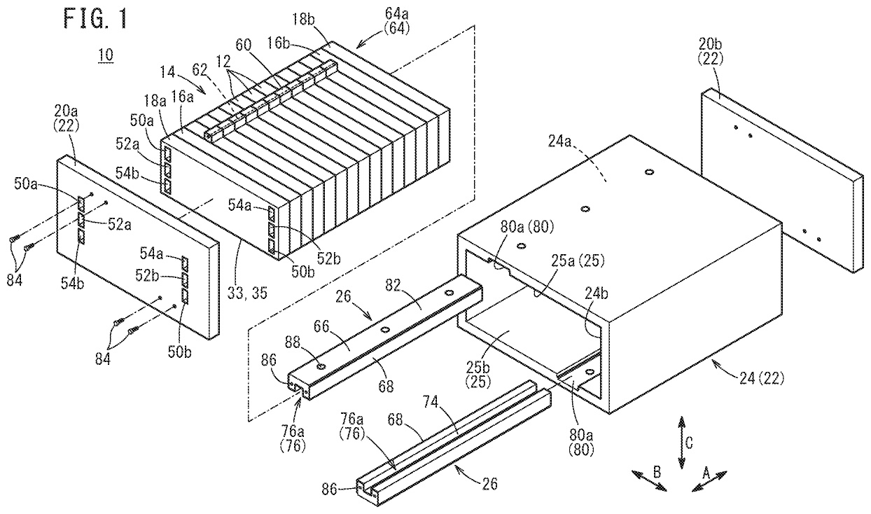

As shown in FIG. 1, a fuel cell stack 10 according to an embodiment of the present invention includes a plurality of power generation cells 12 as units of fuel cells, and the plurality of power generation cells 12 are stacked together in a horizontal direction (indicated by an arrow A) to form a stack body 14. In use, for example, the fuel cell stack 10 is mounted in a fuel cell automobile (not shown). It should be noted that, in the state where the fuel cell stack 10 is mounted in the fuel cell automobile, the stack body 14 may be formed by stacking the power generation cells 12 together in a gravity direction (indicated by an arrow C).

At one end of the stack body 14 in a stacking direction (indicated by the arrow A), a terminal plate 16a is provided. An insulator 18a is provided outside the terminal plate 16a. At the other end of the stack body 14 in the stacking direction, a terminal plate 16b is provided. An insulator 18b is provided outside the terminal plate 16b. Further, a pair of end plates 20a, 20b are provided (stacked) at both ends of the stack body 14 in the stacking direction.

Further, the fuel cell stack 10 includes a case 22 covering the plurality of power generation cells 12 arranged in the stacking direction. The case 22 has a rectangular tube shape, and includes a storage body 24 having an internal storage space 24a capable of storing the plurality of stacked power generation cells 12 (stack body 14) entirely. The storage space 24a extends in the direction indicated by the arrow A, and the storage space 24a is connected to openings 24b provided at both end surfaces of the storage body 24.

The case 22 uses the above end plates 20a, 20b as members closing the pair of openings 24b of the storage body 24. At the time of assembling the fuel cell stack 10, the pair of end plates 20a, 20b are fixed to both end surfaces of the storage body 24 using suitable fixing means (screws using bolts (not shown), welding, adhesion, etc.), respectively. That is, in the embodiment of the present invention, the case 22 includes the storage body 24 and the pair of end plates 20a, 20b, and has structure where the case 22 covers the plurality of power generation cells 12 in a manner that the power generation cells 12 are not exposed to the outside.

Further, the upper sides and the lower sides of the pair of end plates 20a, 20b are tightened together respectively by coupling bars 26 provided between the upper sides and the lower sides of the pair of end plates 20a, 20b. The coupling bars 26 apply a tightening load in a staking direction (indicated by the arrow A) to the stack body 14 through the pair of end plates 20a, 20b. It should be noted that, in the fuel cell stack 10, the tightening load may be applied to the stack body 14 by the storage body 24 to which the pair of end plates 20a, 20b are fixed, instead of applying the tightening load to the stack body 14 by the coupling bars 26. In the assembled state where the stack body 14 formed by stacking the plurality the power generation cells 12 is stored in the case 22, the coupling bars 26 engage with inner surfaces 25 of the storage body 24 (case 22). Further, each of the coupling bars 26 extending on lateral sides of the stack body 14 engages with the stack body 14 to prevent displacement among of the power generation cells 12. Structure of these coupling bars 26 will be described later.

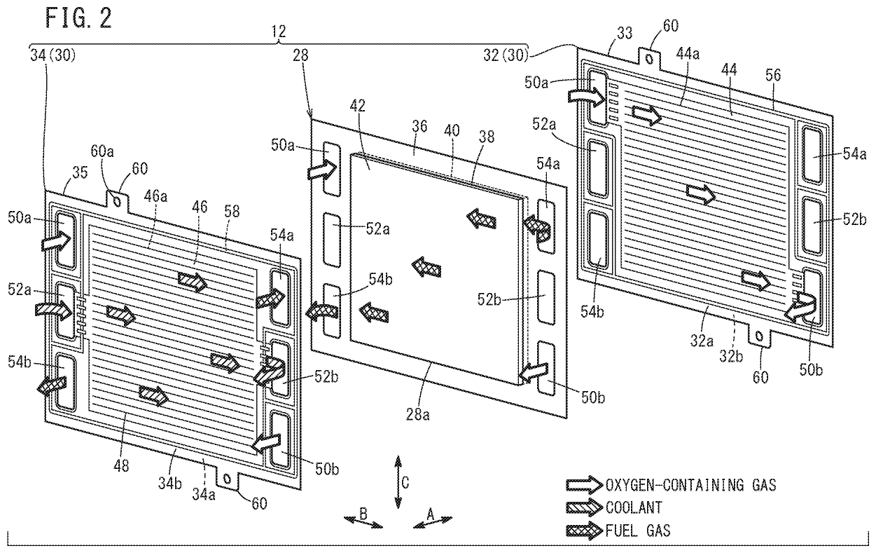

As shown in FIG. 2, the power generation cell 12 of the fuel cell stack 10 includes a resin frame equipped MEA 28, and a plurality of separators 30 sandwiching the resin frame equipped MEA 28. Specifically, the separators 30 includes a first separator 32 provided on one surface of the resin frame equipped MEA 28, and a second separator 34 provided on the other surface of the resin frame equipped MEA 28.

The resin frame equipped MEA 28 of the power generation cell 12 includes a membrane electrode assembly 28a (hereinafter referred to as the “MEA 28a”), and a resin frame member 36 joined to an outer peripheral portion of the MEA 28a, and provided around the outer peripheral portion of the MEA 28a. Further, the MEA 28a includes an electrolyte membrane 38, a cathode 40 provided on one surface of the electrolyte membrane 38, and an anode 42 provided on the other surface of the electrolyte membrane 38. It should be noted that, in the MEA 28a, the electrolyte membrane 38 which protrudes outward may be provided without using the resin frame member 36. A frame shaped film member may be used as the resin frame member 36.

The electrolyte membrane 38 is a solid polymer electrolyte membrane (cation ion exchange membrane). For example, the solid polymer electrolyte membrane is a thin membrane of perfluorosulfonic acid containing water. A fluorine based electrolyte may be used as the electrolyte membrane 38. Alternatively, an HC (hydrocarbon) based electrolyte may be used as the electrolyte membrane 38. Though not shown, each of the anode 42 and the cathode 40 includes a gas diffusion layer comprising a carbon paper, etc., and an electrode catalyst layer. The electrode catalyst layer is formed by porous carbon particles deposited uniformly on the surface of the gas diffusion layer and platinum alloy supported on the surfaces of the porous carbon particles. The electrode catalyst layer is joined to the electrolyte membrane 38.

The resin frame member 36 is provided around the MEA 28a to reduce the cost of the electrolyte membrane 38, and suitably adjusts the contact pressure between the MEA 28a and the first and second separators 32, 34. For example, the resin frame member 36 is made of PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), or modified polyolefin.

The first separator 32 includes an oxygen-containing gas flow field 44 as a passage of an oxygen-containing gas as one of reactant gases, on its surface 32a facing the cathode 40 of the resin frame equipped MEA 28. The oxygen-containing gas flow field 44 includes straight flow grooves or wavy flow grooves formed between a plurality of ridges 44a of the first separator 32 extending in a direction indicated by an arrow B.

The second separator 34 includes a fuel gas flow field 46 as a passage of a fuel gas (e.g., hydrogen-containing gas) on its surface 34a facing the anode 42 of the resin frame equipped MEA 28 (in FIG. 2, for convenience, the flow direction of the fuel gas is shown on the anode 42 of the MEA 28a). The fuel gas flow field 46 includes straight flow grooves or wavy flow grooves formed between a plurality of ridges 46a of the second separator 34 extending in the direction indicated by the arrow B.

Further, a coolant flow field 48 as a passage of a coolant (e.g., water) is provided between a surface 32b of the first separator 32 and a surface 34b of the second separator 34 that are stacked together. When the first separator 32 and the second separator 34 are stacked with each other, the coolant flow field 48 is formed between the back surface of the oxygen-containing gas flow field 44 of the first separator 32 and the back surface of the fuel gas flow field 46 of the second separator 34.

At one end of the first and second separators 32, 34, and the resin frame member 36 in the longitudinal direction (indicated by the arrow B), an oxygen-containing gas supply passage 50a, a coolant supply passage 52a, and a fuel gas discharge passage 54b are provided, respectively. The oxygen-containing gas supply passage 50a, the coolant supply passage 52a, and the fuel gas discharge passage 54b extend through the first and second separators 32, 34 and the resin frame member 36 in the stacking direction (indicated by the arrow A). The oxygen-containing gas supply passage 50a, the coolant supply passage 52a, and the fuel gas discharge passage 54b are arranged in the lateral direction (indicated by the arrow C). The oxygen-containing gas is supplied through the oxygen-containing gas supply passage 50a to the oxygen-containing gas flow field 44. The coolant is supplied through the coolant supply passage 52a to the coolant flow field 48. The fuel gas is discharged from the fuel gas flow field 46 through the fuel gas discharge passage 54b.

At the other end of the first and second separators 32, 34 and the resin frame member 36 in the longitudinal direction indicated by the arrow B, a fuel gas supply passage 54a, a coolant discharge passage 52b, and an oxygen-containing gas discharge passage 50b are provided, respectively. The fuel gas supply passage 54a, the coolant discharge passage 52b, and the oxygen-containing gas discharge passage 50b extend through the first and second separators 32, 34 and the resin frame member 36 in the stacking direction. The fuel gas supply passage 54a, the coolant discharge passage 52b, and the oxygen-containing gas discharge passage 50b are arranged in the lateral direction indicated by the arrow C. The fuel gas is supplied through the fuel gas supply passage 54a to the fuel gas flow field 46. The coolant is discharged from the coolant flow field 48 through the coolant discharge passage 52b. The oxygen-containing gas is discharged from the oxygen-containing gas flow field 44 through the oxygen-containing gas discharge passage 50b.

The oxygen-containing gas supply passage 50a, the oxygen-containing gas discharge passage 50b, the fuel gas supply passage 54a, the fuel gas discharge passage 54b, the coolant supply passage 52a, and the coolant discharge passage 52b extend through the structural parts (the terminal plate 16a, the insulator 18a, and the end plate 20a) at one end of the stack body 14 in the stacking direction, and are connected to pipes (not shown) connected to the end plate 20a. It should be noted that the layout, the number, and the shapes of the oxygen-containing gas supply passage 50a, the oxygen-containing gas discharge passage 50b, the fuel gas supply passage 54a, the fuel gas discharge passage 54b, the coolant supply passage 52a, and the coolant discharge passage 52b are not limited to the illustrated embodiment, and may be designed as necessary depending on the required specification of the fuel cell stack 10.

Further, a first bead 56 is formed by press forming on the surface 32a of the first separator 32. The first bead 56 protrudes toward the resin frame equipped MEA 28, and contacts the resin frame member 36 to form a seal (bead seal). The first bead 56 is provided around the oxygen-containing gas flow field 44, and around the fuel gas supply passage 54a, the fuel gas discharge passage 54b, the coolant supply passage 52a, and the coolant discharge passage 52b, to prevent entry of the fuel gas and/or the coolant into the oxygen-containing gas flow field 44.

A second bead 58 is formed by press forming on the surface 34a of the second separator 34. The second bead 58 protrudes toward the resin frame equipped MEA 28, and contacts the resin frame member 36 to form a seal (bead seal). The second bead 58 is provided around the fuel gas flow field 46, and around the oxygen-containing gas supply passage 50a, the oxygen-containing gas discharge passage 50b, the coolant supply passage 52a, and the coolant discharge passage 52b, to prevent entry of the oxygen-containing gas and/or the coolant into the fuel gas flow field 46.

Each of the separators 30 (first and second separators 32, 34) is a metal separator formed by press forming of a metal thin plate to have a corrugated shape in cross section. For example, the metal plate is a steel plate, a stainless steel plate, an aluminum plate, a plated steel plate, or a metal plate having an anti-corrosive surface by surface treatment. Further, the first and second separators 32, 34 have structure where no elastic material such as resin or rubber is present in their outer marginal portions 33, 35, and metal portions of the first and second separators (metal separators) 32, 34 are exposed from the outer marginal portions 33, 35. It should be noted that carbon separators made of carbon or made of mixed material of carbon and resin may be used as the separators 30.

Further, the first separator 32 and the second separator 34 are be joined together by a joining method such as welding, brazing, or crimping to form a joint separator. At the time of producing the plurality of power generation cells 12, the joint separators and the resin frame equipped MEA 28 are stacked together alternately to have structure where the oxygen-containing gas flow field 44 between the first separator 32 and the resin frame equipped MEA 28, the fuel gas flow field 46 between the resin frame equipped MEA 28 and the second separator 34, and the coolant flow field 48 between the first separator 32 and the second separator 34 are repeatedly arranged in this order.

Further, the separators 30 (first and second separators 32, 34) of the power generation cells 12 have extensions 60 at predetermined positions of the outer marginal portions 33, 35. The extensions 60 may be configured to position the separators 30 with respect to one another at the time of stacking the power generation cells 12 together. In particular, the extensions 60 of the first and second separators 32, 34 are formed continuously with, and integrally from the outer marginal portions 33, 35 of the separators 30. The extensions 60 are made of metal material as well.

For example, the extensions 60 are provided on the upper side and the lower side of the first and second separators 32, 34, and have a rectangular shape including rounded corners in a plan view. The extension 60 on the upper side is present at a position shifted from the center in the longitudinal direction toward the other end in the longitudinal direction, and the extension 60 on the lower side is present at a position shifted from the center in the longitudinal direction toward one end in the longitudinal direction. It should be noted that the positions of the extensions 60 are not limited to the illustrated embodiment. The extensions 60 may be provided at suitable positions of the outer marginal portion (e.g., an intermediate position in the longitudinal direction) of the power generation cell 12.

A through hole 60a is formed in each of the extension 60. The through hole 60a penetrates through the extension 60. At the time of assembling the fuel cell stack 10, a pin 62 extending in the direction indicated by the arrow A is inserted into the through holes 60a. The extensions 60 of the power generation cells 12 function as engaged protrusions 64a (engaged parts 64) which are engaged with the above described coupling bar 26.

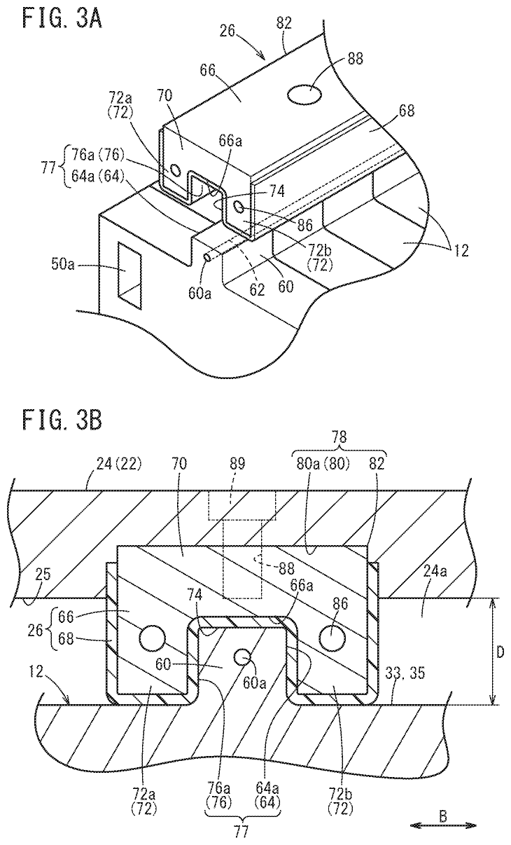

Next, with reference to FIGS. 3A and 3B, structure of the coupling bar 26, and structure of the area around the coupling bar 26 will be described in detail.

The coupling bar 26 according to the embodiment of the present invention is formed in a recessed shape in a front view as viewed in the direction indicated by the arrow A. The coupling bar 26 includes a main body 66 made of metal material, and an insulating resin layer 68 provided at a predetermined position on the surface of the main body 66. The metal material of the main body 66 is not limited specially. For example, aluminum, aluminum alloy, iron, titanium, etc. may be used. Resin material of the insulating resin layer 68 is not limited specially as long as the resin material has electrically insulating performance. For example, polycarbonate, polyphenylene sulfide, polysulfone, a fluororesin, or the same materials as the insulators 18a, 18b may be used. The main body 66 and the insulating resin layer 68 are formed integrally by a suitable technique such as insert molding in a manner that the main body 66 and the insulating resin layer 68 cannot be separated from each other before attachment to the case 22.

Specifically, the main body 66 includes a proximal part 70, and a pair of extensions 72 protruding in the same direction from both lateral ends of the proximal part 70. The overall length of the main body 66 substantially matches the length of the storage body 24 in the axial direction indicated by the arrow A.

The main body 66 includes a body recess 66a surrounded by the proximal part 70 and the pair of extensions 72, on a side closer to the stack body 14. The body recess 66a is continuous in a direction in which the coupling bar 26 extends (in the direction indicated by the arrow A). The insulating resin layer 68 is coated on the surface of the body recess 66a. In the structure, a recess 74 surrounded by the insulating resin layer 68 is formed in the coupling bar 26. In the assembled state of the fuel cell stack 10, the extensions 60 (engaged parts 64) of the stack body 14 are inserted into the recess 74 to function as an engaging recess 76a (engaging part 76) for preventing lateral displacement among the power generation cells 12.

That is, the fuel cell stack 10 includes the extensions 60 (engaged protrusions 64a) of the power generation cells 12 and the recess 74 (engaging recess 76a) of the coupling bar 26 to form engagement structure 77 which engages with the stack body 14. Further, in the engagement state of the engagement structure 77, the coupling bar 26 functions as a spacer for defining a distance D between the outer marginal portions 33, 35 of the power generation cells 12 and the inner surface 25 of the storage body 24.

The insulating resin layer 68 is coated on a side of the main body 66 closer to the stack body 14. Specifically, in a front view, the insulating resin layer 68 extends from one side surface of the proximal part 70 toward one extension 72a, and covers the one extension 72a entirely. Further, the insulating resin layer 68 extends continuously along the bottom surface of body recess 66a (proximal part 70) toward another extension 72b, and covers the other extension 72b entirely to reach the other side surface of the proximal part 70. In the illustrated embodiment, the insulating resin layer 68 is not provided at upper positions of the side surfaces of the proximal part 70, and both side surfaces of the proximal part 70 are exposed (steps of the insulating resin layer 68 are formed). However, the present invention is not limited to this structure. For example, the insulating resin layer 68 may cover both side surfaces of the proximal part 70 entirely.

The thickness of the insulating resin layer 68 is not limited specially as long as the thickness of the insulating resin layer 68 is designed suitably in a manner that no electric current flows between the power generation cells 12 (separators 30) and the main body 66, and electrical conduction can be suppressed. Further, the insulating resin layer 68 is formed on the surface of the main body 66 to have substantially uniform thickness in a front view, and the insulating resin layer 68 is coated uniformly in the direction in which the main body 66 extends.

The inner surface 25 of the storage body 24, and the side of the coupling bar 26 opposite to the stack body 14 (closer to the storage body 24) have positioning structure 78 which defines positions of the storage body 24 and the coupling bar 26 with respect to each other. A groove 80a (positioned recess 80) in correspondence with the shape of the side of the coupling bar 26 closer to the storage body 24 is formed in the inner surface 25 of the storage body 24. Specifically, in a front view, the groove 80a has a depth which makes it possible to accommodate the proximal part 70 of the main body 66 partially, and the width of the bottom of the groove 80a matches the width of the main body 66. The side surface of the groove 80a has a stepped shape corresponding to the side surfaces of the proximal part 70 and the side surfaces of the insulating resin layer 68.

The coupling bar 26 is inserted into the groove 80a without any gap, and positioning displacement of the coupling bar 26 with respect to the case 22 is prevented. That is, the positioning structure 78 is made up of the groove 80a of the storage body 24, and a positioning protrusion 82 comprising the entire side of the coupling bar 26 including the proximal part 70 and the insulating resin layer 68 closer to the storage body 24.

In the state where the coupling bar 26 is fitted into the groove 80a (positioned in the case 22), only the insulating resin layer 68 of the coupling bar 26 is exposed to the storage space 24a of the case 22, and the main body 66 is not exposed. The plurality of extensions 60 of the plurality of power generation cells 12 are inserted into, and fitted to the recess 74 surrounded by the insulating resin layer 68. The outer marginal portions 33, 35 of the plurality of power generation cells 12 are provided at positions adjacent to the insulating resin layer 68 covering the protruding ends of the pair of extensions 72. It should be noted that the outer marginal portions 33, 35 may contact the insulating resin layer 68.

On the other hand, the insulating resin layer 68 is not provided on the side of the coupling bar 26 closer to the storage body 24 (case 22). Therefore, in the state where the coupling bar 26 is inserted into the case 22, the main body 66 contacts the bottom surface of the groove 80a. In this manner, since the main body 66 is directly fitted to the case 22, the main body 66 and the case 22 are firmly engaged with each other.

Further, on the surfaces of the main body 66 facing the end plates 20a, 20b (both end surfaces of the main body 66 in the direction indicated by the arrow A), the insulating resin layer 68 is not provided, and a plurality of end plate threaded holes 86 are formed. Bolts 84 (see FIG. 1) are tightened to the end plate threaded holes 86. For example, the end plate threaded holes 86 are provided at positions where the pair of extensions 72 and the proximal part 70 are coupled together. Further, a plurality of case threaded holes 88 (see also FIG. 1) are formed in a surface of the main body 66 facing the inner surface 25 of the case 22, and bolts 89 are tightened to the case threaded holes 88. The case 22 and the coupling bar 26 are not limited to the structure where the case 22 and the coupling bar 26 are fixed together using the bolts 89, and may be fixed together by any of various fixing means. For example, the case 22 and the coupling bar 26 may be fixed together by pins and pin holes (both not shown) instead of the bolts 89 and the case threaded holes 88. The case 22 and the coupling bar 26 may be fixed together by welding or adhesion. Alternatively, the case 22 and the coupling bar 26 may be fixed together only by insertion of the positioning structure 78 under pressure.

The fuel cell stack 10 according to the embodiment of the present invention basically has the above structure, and operation of the fuel cell stack 10 will be described below.

As shown in FIG. 1, at the time of producing the fuel cell stack 10, the plurality of power generation cells 12 are stacked together to form the stack body 14. At this time, in the plurality of power generation cells 12, the pin 62 is inserted into the through holes 60a of the extensions 60. In this manner, the power generation cells 12 are positioned suitably with respect to each other, and the extensions 60 are in alignment with one another, and stacked together.

On the other hand, the end plate 20b is fixed to one end surface of the storage body 24 of the case 22 beforehand. Further, the coupling bar 26 is attached to each of the grooves 80a formed in the inner surfaces 25 (an upper surface 25a, a lower surface 25b) of the storage body 24. The positioning protrusion 82 of the coupling bar 26 (portions of the main body 66 and the insulating resin layer 68 closer to the storage body 24) is fitted to the groove 80a (positioned recess 80), and the bolts 89 are inserted through the case 22, and tightened to the case threaded holes 88 to fix the coupling bar 26 to the bottom surface of the grooves 80a firmly.

Further, in the state where the coupling bar 26 is fixed, the stack body 14, and the terminal plates 16a, 16b and the insulators 18a, 18b provided at both ends of the stack body 14 in the stacking direction are stored in the storage space 24a of the storage body 24. In the stack body 14, the extensions 60 (engaged protrusions 64a) are inserted into the recess 74 (engaging recess 76a) of the coupling bar 26, and stack body 14 is stored in the storage space 24a along the recess 74.

After the stack body 14 is stored in the storage body 24, the end surface of the storage body 24 is fixed by the end plate 20a. At this time, the bolts 84 are inserted through the end plate 20a, and tightened to the end plate threaded holes 86 of the coupling bar 26. For the purpose of adjusting the tightening load applied to the stack body 14 before tightening the end plate 20a, the thickness of a shim (not shown) provided between the end plate 20a and the insulator 18a is adjusted. As a result, the stack body 14 is stored in the case 22 to place the fuel cell stack 10 is the assembled state.

In the assembled state of the fuel cell stack 10, as shown in FIG. 3B, the extension 60 of each of the power generation cells 12 is engaged with the recess 74 of the coupling bar 26. In the structure, lateral displacement among the plurality of power generation cells 12 inside the case 22 is prevented. For example, even if an impact is applied to the fuel cell vehicle in the direction indicated by the arrow B, and a load at the time of the impact is applied to the fuel cell stack 10, the coupling bars 26 can prevent lateral displacement among the power generation cells 12.

Further, the insulating resin layer 68 exposed to the storage space 24a of the case 22 contacts, or is positioned close to, the outer marginal portions 33, 35 and the extensions 60 of the power generation cells 12. Thus, the electric current does not flow in the coupling bars 26. Therefore, it is possible to prevent leakage of electric current from the fuel cell stack 10 to the outside.

As shown in FIGS. 1 and 2, in the fuel cell stack 10, during power generation, an oxygen-containing gas is supplied to the oxygen-containing gas supply passage 50a through a pipe (not shown) coupled to the end plate 20a, a fuel gas is supplied to the fuel gas supply passage 54a, and a coolant is supplied to the coolant supply passage 52a.

The oxygen-containing gas flows from the oxygen-containing gas supply passage 50a into the oxygen-containing gas flow field 44 of the first separator 32. The oxygen-containing gas flows along the oxygen-containing gas flow field 44 in the direction indicated by the arrow B, and the oxygen-containing gas is supplied to the cathode 40 of the MEA 28a.

In the meanwhile, the fuel gas flows from the fuel gas supply passage 54a into the fuel gas flow field 46 of the second separator 34. The fuel gas flows along the fuel gas flow field 46 in the direction indicated by the arrow B, and the fuel gas is supplied to the anode 42 of the MEA 28a. In each of the MEAs 28a, power generation is performed by electrochemical reactions of the oxygen-containing gas supplied to the cathode 40 and the fuel gas supplied to the anode 42. The oxygen-containing gas supplied to the cathode 40 is partially consumed at the cathode 40, and then, the oxygen-containing gas flows from the oxygen-containing gas flow field 44 to the oxygen-containing gas discharge passage 50b. The oxygen-containing gas is discharged along the oxygen-containing gas discharge passage 50b. Likewise, the fuel gas supplied to the anode 42 is partially consumed at the anode 42, and then, the fuel gas flows from the fuel gas flow field 46 to the fuel gas discharge passage 54b. The fuel gas is discharged along the fuel gas discharge passage 54b.

Further, the coolant supplied to the coolant supply passage 52a flows into the coolant flow field 48 formed between the first separator 32 and the second separator 34, and then, flows in the direction indicated by the arrow B. After the coolant cools the MEA 28a, the coolant is discharged from the coolant discharge passage 52b.

The fuel cell stack 10 according to the present invention is not limited to the above described embodiment. Various modifications can be made in line with the gist of the present invention. For example, in the fuel cell stack 10, the coupling bar 26 is provided on each of the upper surface 25a and the lower surface 25b in the case 22. However, the present invention is not limited in this respect. The coupling bar 26 may be provided at one or three places of the inner surfaces 25 of the case 22. Further, the engaged part 64 (extension 60) of the stack body 14 may be dispensed with in all of the power generation cells 12. The engaged part 64 (extension 60) of the stack body 14 may be provided in some of the power generation cells 12. The fuel cell stack 10 is not limited to have structure where the pair of end plates 20a, 20b are used as part of the case 22. The fuel cell stack 10 may have structure where the entire stack body 14 including the pair of end plates 20a, 20b are placed in the storage body 24, and both ends of the storage body 24 are closed by separate members (lid members).

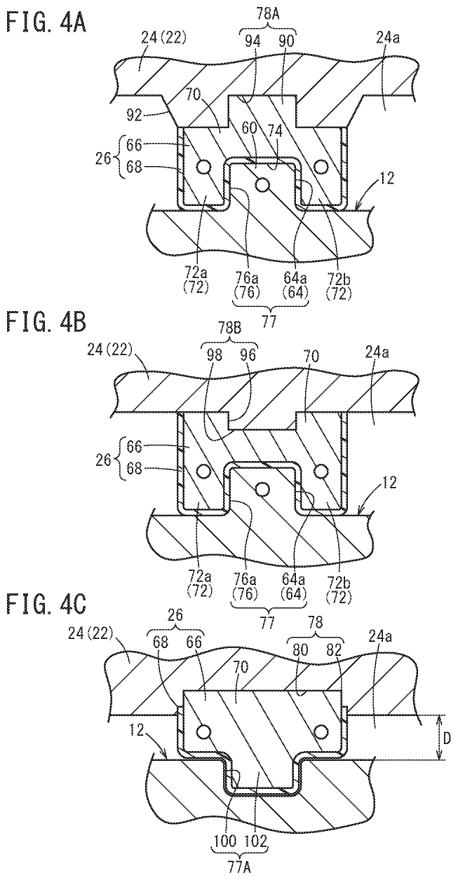

Further, as shown in FIG. 4A, a coupling bar 26 and a case 22 according to a first modified embodiment is different from the above described embodiment in respect of positioning structure 78A for fixing the coupling bar 26 and the case 22 with respect to each other. Specifically, the coupling bar 26 includes a positioning protrusion (ridge) 90 on a side of the proximal part 70 closer to the storage body 24. The positioning protrusion 90 protrudes toward the storage body 24. Further, the insulating resin layer 68 of the coupling bar 26 provided on the main body 66 covers the entire side surfaces of the proximal part 70, in addition to the pair of extensions 72.

On the other hand, the storage body 24 (case 22) has inside the storage body 24 an expansion 92 expanded slightly, and a positioned recess 94 for insertion of the positioning protrusion 90 is provided at the center of the expansion 92 in the width direction. The positioning protrusion 90 is inserted into the positioned recess 94. In this state, the positioning protrusion 90 and the positioned recess 94 are fitted together firmly. In this manner, the coupling bar 26 is positioned without positional displacement from the inner surface 25 of the case 22. It should be noted that, in the coupling bar 26, as in the case of the above described embodiment, the bolts 84 inserted through the case 22 may be tightened to the positioning protrusion 90.

Further, as shown in FIG. 4B, a coupling bar 26 and a case 22 according to a second modified embodiment are also different from the above described embodiment in respect of positioning structure 78B. The coupling bar 26 includes a positioning recess 96, and the storage body 24 includes a positioned protrusion (ridge) 98. The positioned protrusion 98 is inserted into the positioning recess 96, and the positioned protrusion 98 and the positioning recess 96 are fitted together. As a result, the coupling bar 26 is positioned with respect to the inner surface 25 of the case 22 without any positional displacement.

As shown in FIG. 4C, a coupling bar 26 and a power generation cell 12 according to a third modified embodiment are different from the above described embodiment, and the first and second modified embodiments, in respect of engagement structure 77A for engagement of the coupling bar 26 and the power generation cells 12 with each other. Specifically, the plurality of power generation cells 12 include an engaged recess 100 which is recessed inward, in each of the outer marginal portions 33, 35 of the resin frame member 36 and the separator 30. On the other hand, the coupling bar 26 includes an engaging protrusion (ridge) 102 on a side closer to the stack body 14. The engaging protrusion 102 protrudes toward the power generation cells 12.

The engaging protrusion 102 has the same structure as the extension 72 protruding from the proximal part 70 of the main body 66 in the above embodiment. In a front view, the insulating resin layer 68 of the coupling bar 26 extends from one side surface of the proximal part 70 along one of the facing surfaces of the proximal part 70, and then, covers the entire engaging protrusion 102. Further, the insulating resin layer 68 extends continuously along the other of the facing surfaces of the proximal part 70, and reaches the other side surface of the proximal part 70. Therefore, in the state where the coupling bar 26 is fixed to the inner surface 25 of the case 22, only the insulating resin layer 68 is exposed.

In the third modified embodiment, the proximal part 70 of the coupling bar 26 (main body 66) is designed to have a predetermined height to define the distance D between the power generation cells 12 and the inner surface 25 of the storage body 24 (case 22). In this manner, it is possible to prevent the electric current from flowing from the power generation cells 12 to the storage body 24.

The technical concepts and advantages understood from the above embodiments will be described below.

The fuel cell stack 10 includes the positioning structure 78, 78A, 78B and the engaging part 76. In the structure, in the state where the position of the coupling bar 26 with respect to the case 22 is defined, it is possible to prevent lateral displacement among the plurality of power generation cells 12 by the engaging part 76. Further, the coupling bar 26 includes the insulating resin layer 68 on its side closer to the stack body 14. In the structure, even if the engaging part 76 engages with the engaged part 64 of the stack body 14, it is possible to suitably achieve insulation between the coupling bar 26 and the case 22. That is, the coupling bar 26 is positioned sufficiently close to the stack body 14 (without any clearance) for engagement with the power generation cells 12 firmly, and suppress increase in the size of the case 22. Further, using the coupling bar 26, no insulating structure around the plurality of power generation cells 12 is needed. Thus, it is possible to significantly reduce the production cost of the fuel cell stack 10.

Further, the engaged part 64 comprises the engaged protrusion 64a protruding outward from the outer marginal portion 33, 35 of the power generation cell 12, and the engaging part 76 comprises the engaging recess 76a configured to allow the engaged protrusion 64a to be inserted into the engaging recess 76a. In the structure, the coupling bar 26 has a suitable thickness in its part where the engaged protrusion 64a and the engaging recess 76a are engaged with each other. It is possible to suitably determine the distance D between the outer marginal portions 33, 35 of the power generation cells 12 and the inner surface 25 of the case 22. As a result, in the fuel cell stack 10, it is possible to suppress conduction of electricity from the outer marginal portions 33, 35 of the power generation cells 12 to the case 22. It should be noted that the engagement structure 77 of the engaged protrusion 64a and the engaging recess 76a is not limited to the structure shown in FIG. 3B where the entire sides of the engaged protrusion 64a and the engaging recess 76a contact together. It is sufficient that the engaged protrusion 64a and the engaging recess 76a may contact together partially, as long as the engaging recess 76a can receive the load of the engaged protrusion 64a in the direction indicated by the arrow B by engagement between the engaged protrusion 64a and the engaging recess 76a.

Further, the positioning structure 78 comprises the positioned recess 80, 94 or the positioned protrusion 98 provided in the inner surface 25 of the case 22, and the positioning protrusion 82, 90 or the positioning recess 96 of the coupling bar, the positioning protrusion 82, 90 engaging with the positioned recess 80, 94, and the positioning recess 96 engaging with the positioned protrusion 98. The insulating resin layer 68 is not provided on the side of the coupling bar 26 closer to the case 22. As described above, in the fuel cell stack 10, the insulating resin layer 68 is not provided on the side of the coupling bar 26 closer to the case 22. Therefore, it is possible to firmly position the coupling bar 26 and the case 22 by the positioning structure 78 to a greater extent.

Further, the coupling bar 26 comprises the main body 66 and the insulating resin layer 68 configured to cover the surface of the main body 66. The insulating resin layer 68 is configured to prevent exposure of the main body 66 to the inside of the case 22. In the structure, in the fuel cell stack 10, the entire coupling bar 26 in the case 22 is the insulating resin layer 68. Therefore, it is possible to reliably prevent conduction of electricity from the stack body 14 to the coupling bar 26.

Further, the engaged part 64 is formed integrally with the outer marginal portion 33, 35 of the separator 30 of the power generation cell 12. Thus, at the time of producing the separators 30, the engaged parts 64 can be formed integrally, and it is possible to achieve further reduction of the production cost of the fuel cell stack 10.

Further, the separator 30 comprises a metal separator. A metal portion of the separator 30 is exposed from the outer marginal portion 33, 35. Using the metal separator, further reduction of the production cost of the fuel cell stack 10 is achieved. Further, in the fuel cell stack 10, though the metal part of the metal separator is exposed from the outer marginal portions 33, 35, since the coupling bar 26 having the insulating resin layer 68 is present, electric current does not flow in the coupling bar 26 or the case 22. Therefore, it is possible to efficiently collect the electricity generated in power generation.

What is claimed is:

1. A fuel cell stack comprising:
a stack body including a plurality of power generation cells that are stacked together in a stacking direction;
a pair of end plates provided at both ends of the stack body in the stacking direction;
a case containing the stack body; and
a coupling bar provided on a lateral side of the stack body, and between the pair of end plates,
wherein positioning structure is provided in an inner surface of the case and the coupling bar, the positioning structure being configured to define positions of the inner surface of the case and the coupling bar with respect to each other, and
the coupling bar includes an engaging part that engages with an engaged part formed in the stack body, and an insulating resin layer provided on a side of the coupling bar including the engaging part, closer to the stack body.

2. The fuel cell stack according to claim 1, wherein the engaged part comprises an engaged protrusion protruding outward from an outer marginal portion of the power generation cell; and
the engaging part comprises an engaging recess configured to allow the engaged protrusion to be inserted into the engaging recess.

3. The fuel cell stack according to claim 1, wherein the positioning structure comprises:
a positioned recess or a positioned protrusion provided in the inner surface of the case; and
a positioning protrusion or a positioning recess of the coupling bar, the positioning protrusion engaging with the positioned recess, and the positioning recess engaging with the positioned protrusion,
and wherein the insulating resin layer is not provided on a side of the coupling bar closer to the case.

4. The fuel cell stack according to claim 1, wherein the coupling bar comprises a main body and an insulating resin layer configured to cover a surface of the main body; and
the insulating resin layer is configured to prevent exposure of the main body to the inside of the case.

5. The fuel cell stack according to claim 1, wherein the engaged part is formed integrally with an outer marginal portion of a separator of the power generation cell.

6. The fuel cell stack according to claim 5, wherein the separator comprises a metal separator, and a metal portion of the metal separator is exposed from the outer marginal portion.
